(19) United States
(12) Patent Application Publication
(10) Pub. No.: US 2006/0115134 A1
(43) Pub. Date: Jun. 1, 2006

(54) Protective cover for a biometric sensor

(76) Inventor: Douglas Kozlay, Timonium, MD (US)

Correspondence Address: Douglas Kozlay;Suite 304, 9475 Deerco Rd., Timonium, MD, 21093, US

(21) Appl. No.: 10/998,787

(22) Filed: Nov. 29, 2004

(51) Int. Cl. G06K 9/00

(52) U.S. Cl. 382/128

(57) ABSTRACT

A protective cover apparatus is disclosed to help protect a biometric fingerprint sensor and to help conserve battery power. The protective cover is typically implemented by installing it into a retaining track on the frame containing the fingerprint sensor. The cover apparatus, and the method of using it, can be deployed to protect almost any biometric fingerprint sensor implementation. The protective cover can be especially useful when implemented into small, portable, and/or mobile products adapted for high-volume authentication applications aboard small products (e.g., particularly smartcard devices, handheld devices, and other portable devices and applications using fingerprint sensors and battery power). The protective cover can also be used to turn power on and off, to help conserve battery power. The present invention also provides a retraction mechanism for retracting the cover, either by a manual push from the user, or by means of a touch-actuated retraction mechanism.

### BACKGROUND OF THE INVENTION

1. Field of the Invention

The field of the present invention is biometric sensors; more particularly, the invention discloses a protective cover apparatus which helps to protect biometric sensors from damage, and which also helps to conserve battery power.

2. Related Art

There appears to be no directly related art for protecting the surface of biometric sensors from damage, and for helping conserve battery power used by a biometric system, by means of a protective cover that actuates a power switch only when moved into a fully OPEN position.

It must be noted, however, there's at least one fingerprint authentication sensor product embedded on a PCMCIA card (e.g., one is produced by Identix). This (by default) helps protect a sensor if the PCMCIA card is installed in the PCMCIA slot. However, this product does not protect the sensor unless the card is in the slot; even then, this product does not help conserve battery power.

### NECESSITY OF THE INVENTION

Biometric fingerprint sensors are easily susceptible to damage and/or scratches that can limit the precision of the authentication function and/or limit the useful product life of the biometric fingerprint sensor. More specifically, the delicate surfaces of highly mobile and portable products which use biometric fingerprint sensor modules (e.g., smartcards, handheld and portable devices, etc.) are susceptible to damage from impact, scratching, and other hazards (as shown in FIG. 3) because sensor surfaces are made of silicon or other easily-damaged materials. While sensor surfaces can be protectively coated, there's a limit to the amount and thickness of surface coating that can be applied, without interfering with reliable authentication operation.

What is needed in the art is a way to better protect the working surface of the biometric fingerprint sensor that is used to authenticate enrolled users' fingerprints, so that the sensor can have a longer operating life, with consistent precision. What is also needed in the art, is another way to limit and curtail consumption of battery power in a mobile, self-powered biometric fingerprint sensor.

### OBJECTS OF THE INVENTION

Accordingly, it is one object of the invention, to provide a protective cover means for protecting a biometric fingerprint sensor from damage at times when the fingerprint sensor is not in use.

It is another object of the invention, to provide a cover-actuated switch means for turning on and turning off the supply of power to a biometric system, based on the position of the protective cover with reference to the switch (i.e., when the cover is in a fully opened position, the switch can be actuated to couple power to the system; otherwise no power).

### SUMMARY OF THE INVENTION

The present invention provides a protective cover apparatus for better protecting delicate biometric fingerprint sensors from damage. The invention can also be used to help conserve power for portable and/or battery-powered authentication applications. As shown in FIG. 3, the delicate surfaces of highly mobile and portable products using biometric fingerprint sensor modules (e.g., smartcards, handheld and portable devices, etc.) are susceptible to damage from impact, scratching, and other hazards, because sensor surfaces are made of silicon or other easily-damaged materials. While sensor surfaces can be protectively coated, there's a limit to the amount and thickness of surface coating that can be applied, without interfering with reliable authentication operation. The protective cover of the present invention is made of plastic—and/or other equivalent-function, protective substrate(s). In operation, the cover is moved off the fingerprint sensor at time of fingerprint authentication (when the sensor must be used). At time of use, the user moves the cover off of the sensor surface (e.g., with a light pushing movement by a finger). The manually operable cover can be “spring-loaded” so that it automatically returns to its' original position to protect the sensor, as soon as the finger is removed.

One advantage of the cover is to protect the sensor surface during card handling and storage, and thereby make the biometric smartcard more reliable by increasing MTTF, MTBF.

Further, the optional presence of a cover-actuated switch permits this invention to be used to enable power only while the sliding cover is open and the switch is activated.

Another version of the protective cover can be implemented with a motorized opening mechanism, which senses when the user has begun to push the cover off the face of the sensor and which moves the cover to a fully opened position, also coupling power to the biometric circuitry.

### BRIEF DESCRIPTION OF THE DRAWINGS & REFERENCE NUMERALS

### Brief Description of the Drawings

1 Biometric Sensor with Sliding Protective Cover and Switch

2 Biometric Sensor, side view, showing Sliding Protective Cover Closed

3 Example of a Biometric Sensor without a Sliding Cover, Showing Wear and Tear

4 Circuit Detail of Switch Contacts to bring Battery Power On Line when Cover is OPEN

### REFERENCE NUMERALS

10 Biometric Sensor Frame
12 Two “Tracks”, allowing Cover Movement from “CLOSED” to “OPEN” Position
14 Biometric Fingerprint Sensor to be Protected by Cover
16 Protective Cover
18 Return Spring
20 Spring Mount
22 Switch to Detect Opening of Cover
30 Example of an Unprotected Sensor
32 Example of Scratch Damage to Unprotected Sensor
40 Battery Powered Biometric System
42 Battery
44 Electronic Switch Device including Latch to Connect to Battery from the Closing of the Switch until after the Biometric Authentication Process is Completed
46 Switch Contacts (same as switch 22) Activated by Cover in OPEN Position

### DETAILED DESCRIPTION OF THE INVENTION

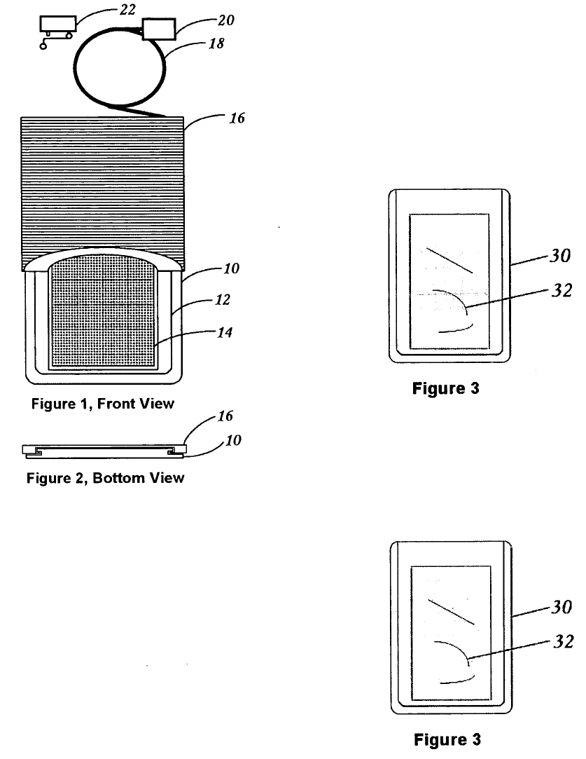

Referring now to FIG. 1, an overview of the present invention is shown. The focal point of the present invention is protective cover 16, which can be used to protectively shield and cover over fragile and/or easily-damaged device surfaces, such as the surface of biometric fingerprint sensor 14. In FIG. 1, cover 16 is shown partially opened, to reveal sensor 14. More specifically, anytime a user fingerprint is not being authenticated, cover 16, when in a fully closed position, fully protects sensor 14. Conversely, in operation—i.e., when it's time to authenticate a user fingerprint—cover 16 is pushed open by the user (e.g., with a small force fingertip push). In this way, the cover 16 is moved along one or more tracks, such as tracks 12 (two such tracks are shown implemented) to a fully opened position. When the cover is pushed to the fully opened position, this exposes fingerprint sensor 14 for use. In another primary embodiment, cover 16 is pushed or slid to the end of tracks 12 until it closes switch 22 when it encounters a stop mechanism, e.g., one or more track “end stops” (not shown), which arrest the cover's motion before it can damage the switch or leave the tracks.

Referring now to FIG. 2, a side view of the present invention is shown, showing the retention of the protective sliding cover by tracks 12 on the sensor frame 10 above the sensor 14.

Referring now to FIG. 3, it is observed that unprotected biometric fingerprint sensor frame and sensor 30 has sustained three instances of scratch damage to the surface of the sensor, such as scratch 32. Note that the frame and sensor 30 has no sliding cover protecting it.

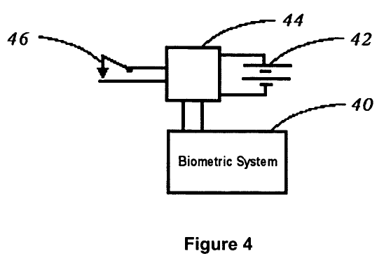

FIG. 4 shows a circuit overview of what happens electronically when protective cover 16 is fully opened to the end of the cover's supporting tracks (which end in one or more track “end stops”), at which point the fully opened protective cover impinges upon and actuates switch 22 (as shown in FIG. 1) to close contacts 46, bringing battery 42 on line (via electronic switch device 44, which further includes a latch to connect to the battery from the closing of the switch 22 and contacts 46), thereby making battery power available for powering the biometric system 40.

It will be readily observed by anyone skilled in the art, that variations of the invention as described herein are possible. Accordingly, the present invention is not limited to the embodiments described herein.

I claim:

1. A system for biometric authentication of a user, comprising:
a biometric fingerprint sensor mounted on a sensor frame;
a protective cover for moving to an open position when said sensor is in use and for moving to a closed position when said sensor is not in use; and
at least one track disposed within said sensor frame in which said protective cover moves.

2. The system of claim 1, further comprising a power switch for coupling battery power to said biometric fingerprint sensor after said power switch is actuated by movement of said protective cover to a fully opened position.

3. The system of claim 1, wherein said cover is moved to the end of said at least one track to permit user access to said sensor in order to perform biometric fingerprint authentication, and wherein said cover is moved and returned to a closed position after completion of said authentication in order to protect said sensor.

4. The system of claim 2, wherein said fully opened position is reached when said cover is moved to the end of said at least one track, and wherein said end of said at least one track further comprises at least one end stop.

5. The system of claim 4, wherein said at least one end stop is adjacent to said power switch, and wherein said power switch couples battery power to said biometric fingerprint sensor after detecting movement of said cover to said fully opened position.

6. The system of claim 5, wherein said switch is actuated to an on position when said cover reaches the end of said at least one track, and wherein said switch when actuated to said on position makes contacts in a circuit to couple battery power to said biometric fingerprint sensor.

7. The system of claim 2, wherein said cover is returned to said closed position through said at least one track from said open position by means of a return spring.

8. The system of claim 7, wherein said return spring is mounted onto and supported by a return spring mount.

9. A method for protecting a biometric fingerprint sensor, comprising the steps of:
manufacturing, providing and installing a protective cover into at least one track disposed on a frame containing a biometric fingerprint sensor;
opening said cover through said track to a fully opened position when it's time to authenticate a user fingerprint;
actuating a switch for coupling a battery to provide electrical power for a biometric system circuit when said cover reaches said fully opened position;
authenticating said user fingerprint while said cover is in said fully opened position and while said biometric fingerprint sensor is exposed for usage; and
returning said cover to a closed position through said at least one track using a return spring after completion of authentication.

10. The system of claim 1, wherein said cover is opened by manually applying an opening push by a user.

11. The system of claim 1, wherein said cover is automatically retracted by a motorized, touch-activated cover opening device.

12. The protective cover of claim 10, wherein said motorized, touch-activated opening is actuated by a small force opening push provided by a user.
